(19) United States
(12) Patent Application Publication
(10) Pub. No.: US 2012/0313568 A1
(43) Pub. Date: Dec. 13, 2012

(54) SOLAR POWERED CHARGING STATION FOR ELECTRIC AND PLUG-IN HYBRID VEHICLES

(75) Inventors: Michael A. Paluszek, Princeton, NJ (US); Gary A. Pajer, Yardley, PA (US); Yosef S. Razin, Princeton, NJ (US); Eloisa M. De Castro, Plainsboro, NJ (US)

(73) Assignee: Princeton Satellite Systems, Plainsboro, NJ (US)

(21) Appl. No.: 13/492,114

(22) Filed: Jun. 8, 2012

Related U.S. Application Data
(60) Provisional application No. 61/494,644, filed on Jun. 8, 2011.

(51) Int. Cl. H02J 7/00

(52) U.S. Cl. 320/101

(57) ABSTRACT

This invention is a solar-powered charging station for electric and hybrid vehicles. A vehicle parks at a space with the charging station and uses a credit card, debit card, cash, smart card or network connection to a database like EZ-Pass to pay for the space and the electricity. The station automatically charges the vehicle as long as it is connected to the station. The station automatically stops charging when the vehicle is fully charged. The customer only pays for the space and the electricity consumed. If the charging circuit is broken the customer must reinsert the smart card or credit card to restart charging. Sufficient funds are removed from the payment method on initiation of charging. Any money not used for charging is put back onto the smart card or account if the user reinserts it prior to leaving.

### CROSS-REFERENCE TO RELATED APPLICATIONS

This application claims the benefit of Provisional Patent Application Ser. No. 61/054,194, filed Jun. 8, 2011 by the present inventors.

### BACKGROUND

The present invention generally relates to charging of electric and hybrid vehicles, and particularly to an improved solar-powered charging station for such vehicles.

As public awareness about the environment and gasoline prices both increase, electric and hybrid vehicles are growing in popularity. Given the proper infrastructure, they will likely become the dominant form of passenger transportation within 50 years. All electric vehicles are limited by range. This restriction has been partially alleviated with deployment of charging stations, but these are currently limited by their convenience.

Originally, charging stations had to be connected to a power source and often this is still the case. Normally this source is the national electric power grid. The initial description of such a charging station was presented in U.S. Pat. No. 735,505 to Haskins (1903) and in the modern era of automobiles in U.S. Pat. No. 4,158,802 to Rose (1979) and in U.S. Pat. No. 4,383,210 to Wilkinson, Jun. 18, 1980. Henze, in U.S. Pat. No. 5,926,004 (1999) extends charging the concept to a charging station for multiple vehicles. However, there are three main problems with grid-tied charging station. The first issue is that the power may be generated from sources that produces considerable carbon dioxide. This reduces or even eliminates the environmental advantage of electric vehicles. Secondly, in many locations, such as parking lots, connecting the station to the grid may be prohibitively expensive. Thirdly, even when a convenient grid tie point is available, the required voltage levels and type of supplied current may require considerable additional equipment.

Despite these draw-backs, grid-tied charging stations have been installed throughout the U.S. Typically, these stations offer Level 2 charging, specified as 240 volts alternating current (AC) and can charge at a rate of up to 20 miles of range per hour. Level 1 is defined as 120 volts a.c. and is only useful for home charging or possibly at an electric vehicle owner's workplace. This is due to the slower rate of charge at Level 1. Charging stations require power to be delivered either at single- or three-phase for a.c. charging or 200-450 volts direct current (d.c.) for fast d.c. charging. a.c. charging and d.c. charging require up to 19 kilowatts and 90 kilowatts, respectively. As a consequence, charging stations require proximity to high voltage and high current supplies. These specifications can make them expensive to install, if power is available at all. This is not always the case, preventing grid-tied charging stations from being more widely available.

Due to these limitations, solar/photovoltaic-powered charging stations for electric vehicles are an attractive alternative. Various patents exist describing such systems (for example in U.S. Pat. No. 5,847,537 to Parmley, 1998, and U.S. Pat. No. 5,926,004 to Rosen, 2008).

However, these systems are limited to only providing power when sunlight is available. Batteries and other energy storage mechanisms can overcome this restriction.

In U.S. Pat. No. 5,315,2227 (1994), Pierson presents a solar array attached to a housing structure containing batteries, and automatic charging of an electric vehicle. By requiring an indoor carport for charging, such charging stations are inherently limited to specific locations. In addition, automatic charging is not always desirable.

Anderson, in U.S. Pat. No. 8,022,667 (2011) allows for remote charging but proposes a variety of complex systems for hands-free vehicle recharging that do not conform to current electric and hybrid vehicle standards. Such a charging system would require additional and complex equipment on those vehicles to successfully function. Further complex hands-free recharging systems are presented in Hoffman (U.S. Pat. No. 5,306,999, 1993)and Langenbahn (U.S. Pat. No. 5,252,078, 1993). Additionally, these two systems are grid-tied.

In U.S. Pat. No. 8,013,569 (Sep. 6, 2011), Hartman primarily requires a number of structural support elements, which may not be required in the general case. Additionally, he limits the number and dimension of energy storage devices such that they are limited by the configuration and dimension of those structural limits.

There are also patents pending that have bearing as well. Uchihashi, in U.S. patent 2011/0133689 (filed 2010), describes a system with a light and switch that are non-essential. Goeltner (U.S. patent 2010/0181957, 2009) describes a solar-powered charging system where the batteries in the electric vehicle are used for storage, which eliminates the ability for nighttime charging.

Littrel (U.S. patent 2010/0156349, filed 2008) and Abrosio (U.S. patent 2009/0313103 A1, filed 2008) describe various computer-implemented aspects of monitoring the energy for charging, discharging, and storing in electric vehicle charging stations, as well as processing the associated monetary transactions but only in combination with a grid-tied station.

Therefore, our invention provides several advantages, including:

to provide a charging system that is not grid-tied, allowing for greater range of location as well as economic and environmental benefits;

to provide a charging system with an energy storage device that can provide power during the nighttime;

to provide a charging station that is not structurally confined to a housing unit or other specific structural limitations;

to provide a charging station with a simple means for connecting to an electric or hybrid vehicle;

to provide a charging station that outputs appropriate power according to currently applicable specifications.

Additional advantages include, but are not limited to, a remote, convenient structure for installation and connecting an electric vehicle, an easy to use system for purchasing energy, control and monitoring software for the solar array, energy storage device, and discharging, multi-vehicle charging, and safety measures to protect the station and users of the station, such as emergency current-cutoff in cases of collision or extreme inclement weather, or general system malfunction. Still further objects and advantages of our invention will become apparent upon consideration of the drawings and description below.

### SUMMARY

In accordance with the present invention a charging system for electric and hybrid vehicles and other devices comprises a means for capturing solar energy, a device for energy storage, safety measures in case of collision, malfunction, or other potentially hazardous event, and means for discharging energy from the energy storage device which is mediated by a computer-implemented monitoring, control, and transaction scheme.

### BRIEF DESCRIPTION OF THE DRAWINGS

FIG. 1 is a diagram illustrating the solar powered charging station, in accordance with an embodiment of the present invention;

FIG. 2 shows the interior components of the solar powered charging station, in accordance with an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

The present invention advantageously provides for a charging station for electric and hybrid vehicles that obtains its power from the sun.

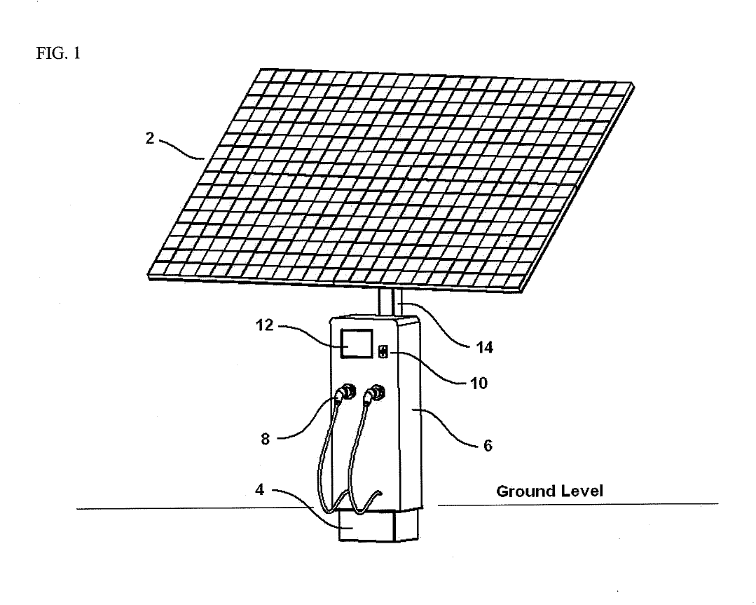

An embodiment of the invention is shown in FIG. 1.

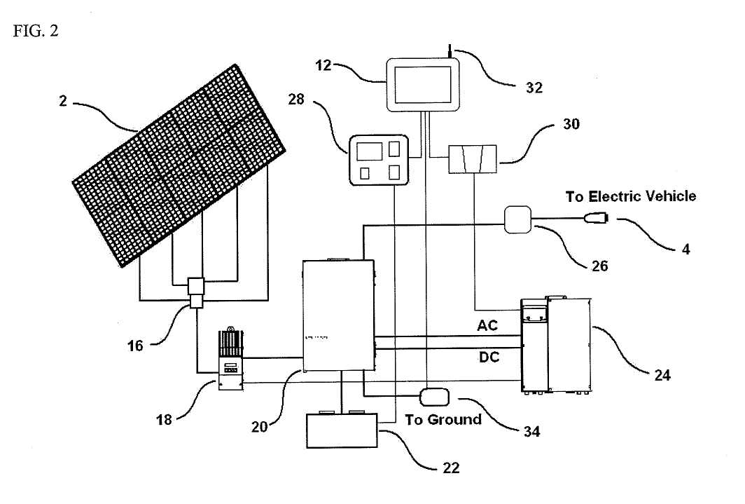

The power delivery, power storage and communications systems of the present invention are shown in FIG. 2.

The solar array 2, collects solar energy for the charging station 6.

The solar array 2 is supported by a solar array support structure 14.

An electric vehicle or alternate electric-powered device can connect to the charging station 6 with the charging plug 8. The electric vehicle may be a pure electric vehicle or a hybrid vehicle.

An energy storage device 22, stores collected power. This may be a battery or a kinetic energy power storage device. Connections are industry standard connections.

A Wi-Fi (IEEE 802.11 standard) interface 32, or other wireless means such as 3G, allows an Internet connection for monitoring the station remotely and for processing credit cards inserted in the credit card reader 10. A touch panel computer 12 controls all station functions and is an interface for user commands. The touch panel computer 12 also displays payment information and charge status.

The solar array 2 is attached to the base via a support structure 14.

A solar combiner box 16 combines the outputs of individual solar panels in the solar array into one output to the maximum power point tracker 18.

A maximum power point tracker 18 maximizes the solar energy capture from the solar array 2.

A breaker panel 20 contains the a.c. breakers, d.c. breakers and disconnects necessary to safely operate the system. All of the power electronics components in the present invention are wired through the breaker panel 20.

A battery 22 stores the energy collected from the solar array 2. The battery is located beneath the station in a waterproof enclosure. This protects the battery in case of a collision.

An inverter 24 inverts the direct current input from the battery 22 into alternating. The alternating current travels to a load subpanel 26 and out to an electric vehicle through the charging plug 8.

A battery management system 28 monitors and controls the battery 22 as well as reports battery state of charge, voltages and temperatures to the station touch panel computer 12.

A communication and configuration monitor 30 reports the inverter 24 health, maximum power point tracker 18 health to the touch panel computer 12.

The touch panel computer 12 reports system health through the internet using a wireless connection 32.

An emergency battery discharge 34 detects collisions and events requiring that the battery be discharged. The emergency battery discharge 34 then discharges the batteries.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

Thus, the solar-powered charging station of the invention provides an environmentally friendly, convenient, safe, and accessible system that provides a basic infrastructure need to the growing electric and hybrid vehicle market.

While the above description of the invention contains much specificity, this should not be construed as a limitation on the scope of the invention, but rather as a single embodiment. Many further configurations are possible such as the addition of further software for communication with the system or not using an inverter at all but purely doing d.c. discharging to the vehicle or powering other devices.

Accordingly, the scope of the invention should not be determined by the embodiments above, but by the appended claims and their legal equivalents.

1) A charging station for electric and hybrid vehicles, comprising:
a. means for capturing solar energy for vehicular charging;
b. an energy storage device;
c. means for discharging from said energy storage device to at least one vehicle;
d. a computer-implemented means for initiating and controlling transactions selected from the group consisting of discharging energy from said energy storage device to at least one vehicle and purchasing energy and discharging energy from said energy storage device to at least one vehicle;
e. an underground compartment for isolating and insulating said energy storage device as well as protecting at least one vehicle and said energy storage device in case of vehicular collision with said charging station;
f. means for preventing current discharge from said charging station and said energy storage device to at least one vehicle in case of vehicular collision with said charging station and extreme environmental conditions;
g. means for joining said means for capturing solar energy to said energy storage device
h. means for joining said energy storage device to said means for discharging
i. means for joining said means for discharging to said means for preventing current discharge
j. means for joining said means for discharging to said computer-implemented means for transactions, whereby the solar energy is captured and stored in said energy storage device and upon initiation of said computer-implemented means for transactions monetary funds are exchanged for energy and via said means for discharging, energy is discharged.

2) The charging station according to claim 1, wherein said energy storage device comprises batteries.

3) The charging station according to claim 1, wherein said means for capturing sufficient solar energy comprises a solar array with at least one photovoltaic panel.

4) The charging station according to claim 1, wherein said means for discharging comprises an alternating current connector.

5) The charging station according to claim 1, wherein said means for discharging comprises a direct current connector.

6) The charging station according to claim 1, wherein said means for discharging comprises means for communication with the vehicle.

7) The charging station according to claim 3, further including a computer-implemented monitoring and control system for maximizing power capture from said solar array;

8) The charging station according to claim 1, further including a one-axis or two-axis pointing mechanism to align the panel normal to the sun.

9) The charging station according to claim 8, further including a computer-implemented means for controlling said two-axis pointing mechanism to align the panel normal to the sun.

10) The charging station according to claim 9, further including a ground-positioning system receiver to determine the station location, date, and time which is then used to determine the array angles.

11) The charging station according to claim 1, further including a connection to the electric grid.

12) The charging station according to claim 1, further including a connection to a wireless network.

13) A stand-alone electric generation station, comprising:
a. means for capturing solar energy for charging;
b. an energy storage device;
c. means for discharging from said energy storage device;
d. an underground compartment for isolating and insulating said energy storage device as well as protecting the user and said energy storage device in case of system malfunction or external emergency;
e. a means for preventing current discharge from said charging station and said energy storage device in case of system malfunction or external emergency;
f. means for joining said means for capturing solar energy to said energy storage device
g. means for joining said energy storage device to said means for discharging
h. means for joining said means for discharging to said means for preventing current discharge, whereby the solar energy is captured and stored in said energy storage device and upon initiation of said computer-implemented means for transactions monetary funds are exchanged for energy and via said means for discharging, energy is discharged.

14) The charging station according to claim 13, wherein said means for substantial energy storage comprises batteries.

15) The charging station according to claim 13, wherein said means for capturing sufficient solar energy comprises a solar array with at least one photovoltaic panel.

16) The charging station according to claim 13, wherein said means for discharging comprises an alternating current connector.

17) The charging station according to claim 13, wherein said means for discharging comprises a direct current connector.

18) The charging station according to claim 13, further including a connection to the electric grid.

19) The charging station according to claim 13, further including a computer-implemented means for initiating and controlling transactions such that energy can be purchased and discharged from said energy storage device.
